(19) United States
(12) Patent Application Publication
(10) Pub. No.: US 2013/0117102 A1
(43) Pub. Date: May 9, 2013

(54) METHOD AND APPARATUS FOR REPLACING AN ADVERTISEMENT

(71) Applicants: Mauro Barbieri, Eindhoven (NL); Serverius Petrus Paulus Pronk, Eindhoven (NL); Johannes Henricus Maria Korst, Eindhoven (NL)

(72) Inventors: Mauro Barbieri, Eindhoven (NL); Serverius Petrus Paulus Pronk, Eindhoven (NL); Johannes Henricus Maria Korst, Eindhoven (NL)

(73) Assignee: KONINKLIJKE PHILIPS ELECTRONICS N.V., EINDHOVEN (NL)

(21) Appl. No.: 13/810,242

(22) PCT Filed: Jul. 8, 2011
(86) PCT No.: PCT/IB2011/053043

§ 371 Date: Jan. 15, 2013

(30) Foreign Application Priority Data
Jul. 20, 2010 (EP) 10170156.3

(51) Int. Cl. G06Q 30/02

(52) U.S. Cl. CPC G06Q 30/0244
USPC 705/14.43

(57) ABSTRACT

A method and apparatus (100) for replacing an advertisement is described. A negative input regarding a current advertisement is received (step 200). At least one feature of the current advertisement is identified which is hypothezied to have caused the received negative input (step 204). A new advertisement that differs to the current advertisement in respect of the identified at last one feature is selected )step 210). The current advertisement is replaced with the selected new advertisement (step 212).

### FIELD OF THE INVENTION

The present invention relates to a method and apparatus for replacing an advertisement.

### BACKGROUND OF THE INVENTION

Broadcasters, web services, software providers, etc, allow users access to free content but, at the same time, expose users to commercial advertisements since advertising is their main source of revenue. For example, TV broadcasters offer free TV content to attract viewers but sell advertisement space to advertisers for inserting commercial advertisements between the TV content. Similarly, many web sites offer free services (e.g. Internet searches) to attract visitors to their website but sell space for commercial advertisements in the form of graphical, animated banners or ‘sponsored links’

Although some advertisements may appeal to users, most of the advertisements are annoying for a user, particularly if the user is not interested in the products or services being advertised. The user is mostly interested in the service or content being provided and does not want their experience to be disrupted by advertisements. Users want to feel in control, and in the case of advertisements being automatically placed within or around other content (e.g. web pages, personal TV channels, user interfaces, etc), the user likes to have the possibility of not watching the advertisements or even removing the advertisements if they are not interested in them.

To deal with this, some systems make advertisements at least more acceptable to the user by targeting the advertisements to each user based on the behavior of each user, the preferences of each user (for example, preferred artist or a movie genre) and, more importantly, to the context in which the advertisements are placed. For example, some systems use keywords, domain names, topics, demographic targets, etc, specified in a user profile to only place advertisements on websites and web pages containing content that is relevant to the user and, also, to choose advertisements having content that will be of interest to the user (for example, because the content is listed in the user profile or is rated highly in the user profile).

In one traditional advertisement placement system, given a certain piece of content (e.g. a webpage, a TV show, etc) or context (e.g. a query sent to a search engine, the schedule of a personal channel, etc), the system selects one or more advertisements from a database of advertisements that fits the content of a user profile (e.g. by demographics, viewing history, or purchasing history). The system calculates a like-degree for each advertisement based on the user profile. Such a like-degree may be calculated using existing known machine learning techniques such as naïve Bayesian classification or collaborative filtering and expresses an estimate of how much the user likes the advertisement. The like-degrees are used to prioritize the advertisements that can be placed.

However, although systems such as this are able to provide advertisements to a user that are more likely to be relevant and of interest to the user, there is no guarantee that the system will not render advertisements to the user that the user dislikes or is of no interest to them because a user profile only generally lists content that is liked by a user.

In some systems, this is overcome by allowing a user the option to remove a current advertisement, provide an indication that a current advertisement is disliked or to give a poor rating (typically on a two, a five, or a ten star rating scale) to a current advertisement. For example, US 2009/0287566 discloses a system in which a user is required to indicate whether they like/dislike advertisements and also the reasons why they like/dislike the advertisements in order for the system to select advertisements that are likely to be acceptable to the user. Also, in some systems, when a user carries out one of the options listed above, the system black lists the current advertisement to prevent it from being rendered to the user in the future and adapts the user profile so that the chance of another advertisement that is similar to the current advertisement being rendered to the user is lower.

However, this does not guarantee that advertisements similar to the removed/disliked/poorly rated advertisement will not be rendered to the user in the future because the placement of advertisements depends on various factors, which the user can only indirectly control. For example, the system adapts the user profile by treating all features of the advertisement equally. This means that the system requires many more negative ratings of other advertisements that are similar to the current advertisement but that have different combinations of features before the system can learn specifically what the user likes and dislikes and before the system can therefore produce useful recommendations. The user is required to repeatedly indicate to the system that they are not interested in an advertisement and the system requires a relatively high number of ratings before it can produce useful recommendations, which can be frustrating for the user.

### SUMMARY OF THE INVENTION

The invention seeks to provide a method and apparatus that provides targeted advertising in which more relevant advertisements are automatically provided to a user without the user having to repeatedly indicate which adverts that they like/dislike.

This is achieved, according to an aspect of the invention, by a method for replacing an advertisement, the method comprising the steps of: receiving a negative input regarding a current advertisement; identifying at least one feature of the current advertisement which is hypothesized to have caused the received negative input; selecting a new advertisement that differs to the current advertisement in respect of the identified at least one feature; and replacing the current advertisement and/or any advertisement similar to the current advertisement with the selected new advertisement.

This is achieved, according to another aspect of the invention, by apparatus for replacing an advertisement, the apparatus comprising: a user interface for receiving a negative input regarding a current advertisement; an identifier for identifying at least one feature of the current advertisement that is hypothesized to have caused the received negative input; a selector for selecting a new advertisement that differs to the current advertisement in respect of the identified at least one feature; and a processor for replacing the current advertisement and/or any advertisement similar to the current advertisement with the selected new advertisement.

In this way, the user is provided with advertisements that are relevant to them more quickly without the user having to repeatedly indicate which adverts they like/dislike because the new advertisement differs in respect of the at least one feature hypothesized to have caused the received negative input. This is in contrast to all features being treated equally when a negative input is received such that all features are considered to be disliked by the user, in which case many more ratings are required by a user before the system can produce useful recommendations. The user is therefore required to rate (provide a negative input for) fewer advertisements before the apparatus can generate more relevant advertisements for the user.

The method may further comprise the step of replacing any advertisement similar to the current advertisement with another new advertisement. In this way, negatively rating an advertisement has the immediate effect of replacing, more radically than would be the case if a conventional recommender would be used, other advertisements similar to the current advertisement that may be present, such that the replaced advertisements will differ in at least the at least one feature.

The another new advertisement may be selected such that it differs to the advertisement similar to the current advertisement in respect of the identified at least one feature or differs to the current advertisement in respect of the identified at least one feature.

The method may further comprise the step of rendering advertisements to a user that do not include at least the identified at least one feature. In this way, the user is presented with advertisements that are more likely to be relevant.

The negative input may be one of an instruction to remove the current advertisement, an indication that the user dislikes the current advertisement or a rating of the current advertisement that is below a predetermined value. In this way, the user has more control over how to indicate their preferences of advertisements.

The at least one feature may comprise metadata associated with the current advertisement. In this way, the method uses existing data in order to provide more relevant advertisements.

The step of identifying at least one feature of the current advertisement which is hypothesized to have caused the received negative input may comprise identifying at least one feature of the current advertisement which is hypothesized to have caused the received negative input based on at least one of a user profile and discriminative power.

The method may further comprise the step of maintaining a record of advertisements that have received a negative input and features associated with the advertisements and, for each feature, an indication as to whether it is hypothesized to have caused the received negative input. In this way, future selection of advertisements will be more accurate.

The method may further comprise the step of using the record of advertisements that have received a negative input and features associated with the advertisements and, for each feature, the indication as to whether it is hypothesized to have caused the received negative input to update a user profile. In this way, a record is stored and can be used in future to provide more accurate results in providing advertisements that are more relevant to the user.

The step of selecting a new advertisement that differs to the current advertisement in respect of the identified at least one feature may comprise selecting a new advertisement having the identified at least one feature most different to the identified at least one feature of the current advertisement. In this way, the likelihood of a more relevant advertisement being provided to the user is increased.

The step of selecting a new advertisement that differs to the current advertisement in respect of the identified at least one feature may comprise selecting a new advertisement having the identified at least one feature that best fits a user profile. In this way, the new advertisement is more likely to be of interest to the user.

### BRIEF DESCRIPTION OF THE DRAWINGS

For a better understanding of the invention, and to show more clearly how it may be carried into effect, reference will now be made, by way of example only, to the accompanying drawings in which:

FIG. 1 is a simplified schematic of apparatus for replacing an advertisement according to the invention; and

FIG. 2 is a flowchart of a method for replacing an advertisement according to the invention.

### DETAILED DESCRIPTION

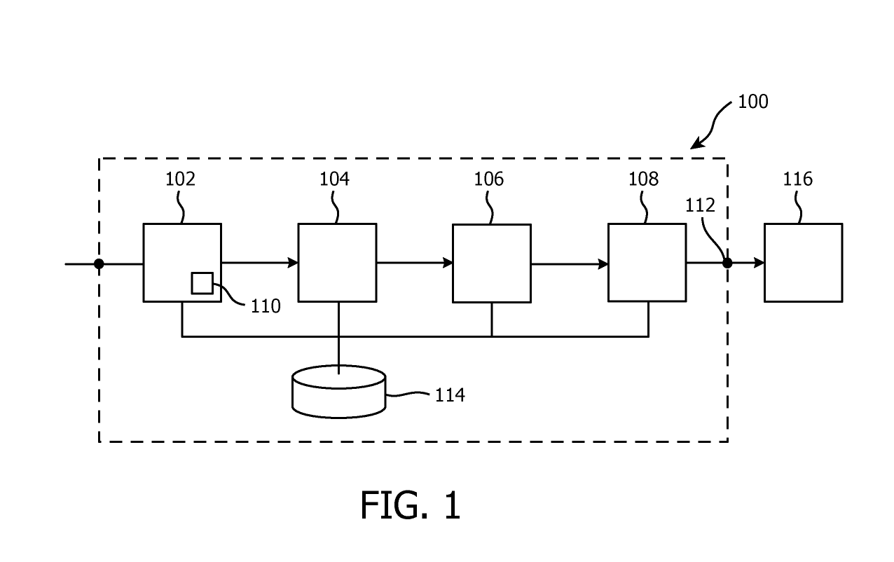

With reference to FIG. 1, the apparatus 100 comprises a user interface 102 for receiving an input regarding a current advertisement, the input including a negative or positive input regarding the current advertisement. The current advertisement may be, for example an advertisement that has been inserted around content items (e.g. around TV shows in a personal channel). The user interface 102 may be integrated in the apparatus 100 (as shown) or may be separate from the apparatus 100 and wirelessly connected to or wired to the apparatus 100. The output of the user interface 102 is connected to an identifier 104. The output of the identifier 104 is connected to a selector 106. The output of the selector 106 is connected to a processor 108. The processor 108 may be wirelessly connected to or wired to the external device 116 via an output terminal 112. Alternatively, the apparatus 100 may be integrated in the external device 116. The external device 116 may be, for example, a TV, a stereo, a computer, a screen, or the like, or a mobile device such as a mobile terminal, a portable TV, or the like. The user interface 102, the identifier 104 and the selector 106 are connected to a storage device 114. The user interface 102 may comprise a rendering device 110 for rendering advertisements to a user. Alternatively, the processor 108 may control the external device 116 to render advertisements to a user.

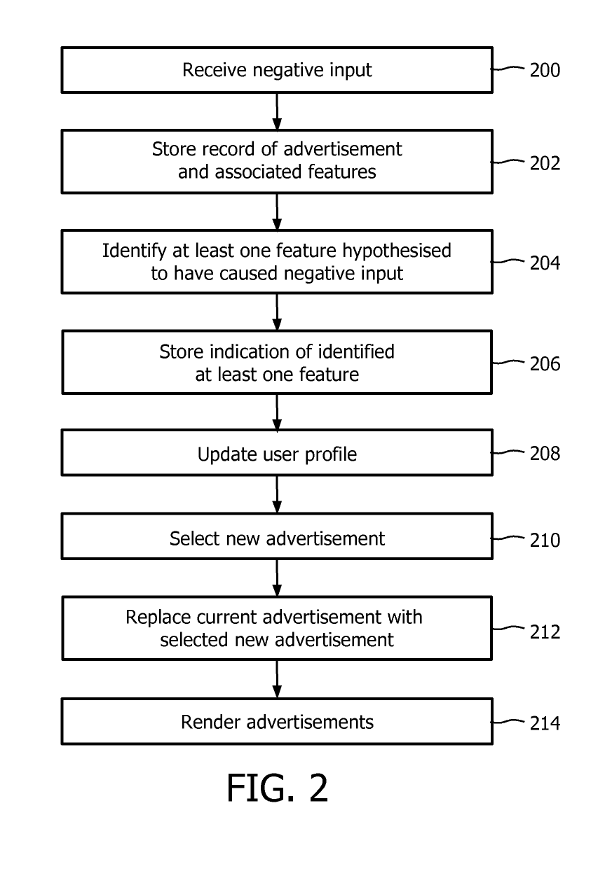

The operation of the apparatus 100 will now be described with reference to the flowchart shown in FIG. 2.

The user interface 102 receives a negative input regarding a current advertisement (step 200). The negative input is one of an instruction to remove the current advertisement, an indication that the user dislikes the current advertisement or a rating of the current advertisement that is below a predetermined value (typically on a two, a five, or a ten star rating scale).

The user interface 102 communicates with the storage device 114 and the storage device 114 stores a record of the current advertisement that has received the negative input and also the features associated with the current advertisement (step 202). The features comprise metadata associated with the current advertisement, which can include attributes (e.g. genre) and related values (e.g. action, romance, etc). In the case of video advertisements, for example, the metadata associated to the video advertisements may be divided into two subsets of features: metadata related to the product advertised such as product category, target group, brand name, etc, and metadata related to the video advertisement itself such as genre, cast, etc.

The user interface 102 also communicates the negative input regarding the current advertisement to the identifier 104. Upon receiving the negative input, the identifier 104 communicates with the storage device 114 to access the features associated with the current advertisement and identifies at least one feature of the current advertisement which is hypothesized to have caused the received negative input (step 204). For example, the identifier 104 identifies at least one feature of the current advertisement which is hypothesized to have caused the received negative input based on a user profile, for instance, by choosing a feature with the most discriminative power, e.g. a feature that has the most negative ratings or an attribute with the lowest number of possible values. One approach is to keep statistics of how often each of the relevant features was present in the advertisements that were offered to the user during a viewing history of a specified length and how often the presentation of such an advertisement resulted in a negative user input. Another approach is to simply use a pre-defined order of features. A measure of the discriminative power can be determined and used in the identification step.

The identifier 104 may identify a value for the attribute as the at least one feature of the current advertisement hypothesized to have caused the negative input. In the case of video advertisements, the identifier 104 may associate the negative input regarding the current advertisement only to one subset of the features (either product-related or video-related) assuming that either the product or the video are uninteresting for the user. The next time the user interface 102 receives a negative input regarding an advertisement similar to the current advertisement, the identifier 104 either associates the negative input to both subsets of features, concluding that the user is interested in neither the product nor the video, or associates the negative input to the other subset of features, concluding that this subset of features is considered uninteresting.

The storage device 114 stores an indication for the at least one feature indicating that the at least one feature is hypothesized to have caused the received negative input (step 206).

The storage device 114 therefore maintains a record of advertisements that have received a negative input, features associated with the advertisements and, for each feature, an indication as to whether it is hypothesized to have caused the received negative input. This record is called a ‘hypotheses’ table because it keeps track of the hypotheses that have been made or that have been discarded for each advertisement for which the user interface 102 has received a negative input. An example of a hypotheses table is shown below:

| Advertisement ID | Product category dislike | Ad genre dislike |
|---|---|---|
| 1001 | Yes | No |
| 1002 | No | Yes |

The hypotheses table contains a number of domains that indicate whether a specific feature (e.g. product category, advertisement genre, etc) is disliked for a particular advertisement. The number of domains that the storage device 114 stores changes depending on how many times a user rates consistently two sub-domains (e.g. if a user always rates both product and video-related advertisements, it does not make sense to separate product and video domains for this user). The storage device 114 may store different features in the hypotheses table for each user and this may depend on the user profile.

Each time the user interface 102 receives a negative input relating to a current advertisement, the identifier 104 communicates with the storage device 114 to update the hypotheses table according to a predetermined strategy or from a strategy learned from interaction with the user using a dedicated machine learning algorithm. For example, when a negative input is received by the user interface 102, the identifier 104 updates the hypotheses table by inserting a “yes” in the domain indicating the particular feature associated with the advertisement which is hypothesized to have caused the negative input and a “no” in the domain for all other features associated with the advertisement. Alternatively, the identifier 104 may insert a “yes” in more than one domain if more than one feature is hypothesized to have caused the negative input. As a specific example, the negative input may be applied to the feature that the advertisement relates to the video genre, or to the feature of the product category of the advertisement, or to both features. The identifier 104 may use a binary system to update the hypotheses table, with a value of 1 indicating a feature is disliked (hypothesized to have caused the negative input) and a value of 0 indicating a feature is liked (not hypothesized to have caused the negative input).

Each time the user interface 102 receives a negative input relating to a current advertisement, the identifier 104 communicates with the storage device 114 to update the entries in a hypotheses table for that advertisement and also advertisements similar to the current advertisement for which the user interface 102 received the negative input.

The identifier 104 uses the records stored in the hypotheses table to update a user profile (step 208). For example, if the identifier 104 has hypothesized that the genre of the advertisement has caused a user to input the received negative input into the user interface 102, then the identifier 104 updates features in the user profile that relate to the genre by applying one or more negative counts to those features, so that they appear lower in the preferences of the user.

At any one time, the identifier 104 may use the most current results recorded in the hypotheses table to reinterpret the reasons for earlier negative inputs and may adapt the table to indicate that a different feature is hypothesized to have caused the received negative input than that which was previously hypothesized to have caused the received negative input.

The identifier 104 outputs the identified at least one feature of the current advertisement into the selector 106 and the selector 106 selects a new advertisement that differs to the current advertisement in respect of the identified at least one feature (step 210). The selector 106 may select the new advertisement from advertisements that have been locally cached/stored in the storage device 114 or the selector 106 may download the new advertisement from an external source.

This may involve the selector 106 selecting a new advertisement that has a different value for the attribute of a disliked value (a value hypothesized to have caused the received negative input) or selecting a new advertisement that does not include a disliked value (a value hypothesized to have caused the received negative input), i.e. selecting a new advertisement that does not have the disliked value as a value for any of the attributes. In the former case, the selector 106 may select a new advertisement having the identified at least one feature most different to the identified at least one feature of the current advertisement (i.e. which is as different as possible from the current advertisement).

Alternatively, the selector 106 may select a new advertisement having the identified at least one feature that best fits a user profile. In order to achieve this, the selector 106 estimates the probability that the user will like and, by assumption, watch a certain advertisement based on the user profile. In other words, the selector 106 calculates the like-degree for each advertisement based on the user profile and selects the advertisement having the highest calculated like-degree as the new advertisement. The like-degree may be represented by values in the range [0,1] and may be calculated using a subset of the features representing a meaningful sub-domain of the metadata associated to the advertisement. For example, the metadata associated to video advertisements can be divided into two sub-domains: metadata related to the product advertised such as product category, target group, brand name, etc, and metadata related to the video advertisement itself such as genre, cast, etc.

The selector 106 may select a new advertisement having the identified at least one feature most different to the identified at least one feature of the current advertisement but which has a high like-degree. In order to achieve this, the selector 106 calculates, for each new advertisement, the product between the like-degree calculated for the new advertisement and the dissimilarity between the new advertisement and the current advertisement. The dissimilarity between the new and current advertisements is calculated using a distance measure in the advertisements feature space (e.g. the Jaccard distance). The selector 106 then selects the advertisement having the highest product as the new advertisement.

The selector 106 communicates the selected new advertisement to the processor 108 and the processor 108 replaces the current advertisement with the selected new advertisement (step 212). The processor 108 may also replace any advertisement similar to the current advertisement with the selected new advertisement or with another new advertisement different to the new advertisement. The another new advertisement may be selected such that it differs to the advertisement similar to the current advertisement in respect of the identified at least one feature or differs to the current advertisement in respect of the identified at least one feature.

The processor 108 controls the external device 116 via the output terminal 112 to replace the current advertisement on the external device 116 with the selected new advertisement (step 214). Alternatively, or in addition, the processor 108 controls the rendering device 110 to replace the current advertisement on the rendering device 110 with the selected new advertisement (step 214).

The processor 108 also controls the rendering device 110 and/or the external device 116 to render advertisements to a user that do not include at least the identified at least one feature (step 214).

A specific embodiment will now be described where the apparatus has placed a BMW advertisement having “action” as the main genre in a personal movie channel and the user interface 102 has received a negative input regarding the advertisement.

The selector 106 selects a new advertisement which is of a different genre (e.g. “documentary/informative”) but still about cars because the selector 106 has calculated car advertisements to have a high like-degree using the part of the user profile about products. In this case, the hypothesis is that the genre being cars is not the reason for the user not liking the advertisement. The selector 106 selects a new advertisement of a different genre rather than a new advertisement with a different cast, because genre is considered to have more discriminative power than cast. The selector 106 then communicates the selected new advertisement to the processor 108, which replaces the current advertisement with the selected new advertisement.

The apparatus 100 has been described in terms of replacing an advertisement with another advertisement. The advertisements may be present, for example, in web pages, banners, online magazines, pre-roll video advertisements, and the like. The apparatus 100 can also be used to replace, not only a negatively rated advertisement, but also to replace other (similar) advertisements present in the same page or TV channel or website. The apparatus 100 may also be applied to the case of positive ratings and selection of items based on the positive ratings. In this case, the user interface 102 receives a positive input regarding a current advertisement and the identifier 104 communicates with the storage device 114 to update the hypotheses table according to the received positive input. For example, the identifier 104 may communicate with the storage device 114 to boost certain features in the hypotheses table in a positive sense, which can lead to more relevant recommendations in a shorter learning time.

The apparatus 100 described herein can be applied to TV sets, personal video recorders (PVRs), set-top boxes, audio systems (including portable audio), services (including Internet video and music services) and any other system where recommendations are used. In addition, the apparatus 100 can be applied in many content-based and context-based advertising systems, such as web advertising.

Although embodiments of the present invention have been illustrated in the accompanying drawings and described in the foregoing detailed description, it will be understood that the invention is not limited to the embodiments disclosed, but is capable of numerous modifications without departing from the scope of the invention as set out in the following claims.

‘Means’, as will be apparent to a person skilled in the art, are meant to include any hardware (such as separate or integrated circuits or electronic elements) or software (such as programs or parts of programs) which reproduce in operation or are designed to reproduce a specified function, be it solely or in conjunction with other functions, be it in isolation or in co-operation with other elements. The invention can be implemented by means of hardware comprising several distinct elements, and by means of a suitably programmed computer. In the apparatus claim enumerating several means, several of these means can be embodied by one and the same item of hardware. ‘Computer program product’ is to be understood to mean any software product stored on a computer-readable medium, such as a floppy disk, downloadable via a network, such as the Internet, or marketable in any other manner.

1. A method for rendering an advertisement, the method being executed by an apparatus that comprises a user interface and a processor, the method comprising:
receiving, via the user interface, a negative input regarding a current advertisement;
identifying at least one feature of the current advertisement to have caused the received negative input;
selecting a new advertisement that differs from the current advertisement in respect of the identified at least one feature; and
replacing by the lrocessor, the current advertisement with the selected new advertisement.

2. The method according to claim 1, further comprising replacing the advertisement similar to the current advertisement with another new advertisement.

3. The method according to claim 1, further comprising rendering advertisements that do not include the identified at least one feature.

4. The method according to claim 1, wherein the negative input is one of an instruction to remove the current advertisement, an indication that the user dislikes the current advertisement or a rating of the current advertisement that is below a predetermined value.

5. (canceled)

6. The method according to claim 1, wherein the identifying at comprises identifying at least one feature of the current advertisement which is hypothesized to have caused the received negative input based on at least one of a user profile and discriminative power of the at least one feature.

7. The method according to claim 1, further comprising maintaining a record of advertisements that have received a negative input and features associated with the advertisements and, for each feature, an indication as to whether it is hypothesized to have caused the received negative input.

8. The method according to claim 7, further comprising using the record of advertisements that have received the a--negative input and features associated with the advertisements and, for each feature, the indication as to whether it is hypothesized to have caused the received negative input to update a user profile.

9. The method according to claim 7, further comprising receiving a positive input regarding a current advertisement and updating the record according to the received positive input.

10. The A method according to claim 1, wherein the a comprises selecting a new advertisement having the identified at least one feature most different from the identified at least one feature of the current advertisement.

11. (canceled)

12. A non-transitory computer program product comprising a plurality of program code portions for causing a computer to carry out the method according to claim 1.

13. An apparatus for redering an advertisement, configured to replace a current advertisement, the apparatus comprising:
a user interface for receiving a negative input regarding the current advertisement;
an identifier for identifying at least one feature of the current advertisement to have caused the received negative input;
a selector for selecting a new advertisement that differs from the current advertisement in respect of the identified at least one feature; and
a processor for replacing the current advertisement with the selected new advertisement.

14. The apparatus according to claim 13, further comprising a rendering device for rendering advertisements that do not include at least the identified at least one feature.

15. (canceled)

16. The method according to claim 1, further comprising calculating a like-degree for the new advertisement based on a user profile, calculating a product between the like-degree calculated for the new advertisement and a measure of dissimilarity between the new advertisement and the current advertisement, and selecting the new advertisement having the highest product.

17. The method according to claim 1, further comprising a value of an attribute of the current advertisement as the feature that is hypothesized to have caused the received negative input, and selecting the new advertisement that has a different value for the attribute.

18. The apparatus according to claim 13, wherein the selector is configured to calculate a like-degree for the new advertisement based on a user profile, to calculate a product between the like-degree calculated for the new advertisement and a measure of dissimilarity between the new advertisement and the current advertisement, and to select the new advertisement having the highest product.
